(19) United States
(12) Patent Application Publication
(10) Pub. No.: US 2005/0072484 A1
(43) Pub. Date: Apr. 7, 2005

(54) Conduit for drawing off and/or supplying a fluid

(76) Inventor: Hans-Georg Haertl, Karlsruhe (DE)

Correspondence Address: PERMAN & GREEN, 425 POST ROAD, FAIRFIELD, CT, 06824, US

(21) Appl. No.: 10/928,535

(22) Filed: Aug. 27, 2004

(30) Foreign Application Priority Data
Sep. 12, 2003 (DE) 103 42 304.4

(51) Int. Cl. F16L 11/00

(52) U.S. Cl. 138/114; 138/109

(57) ABSTRACT

A conduit for drawing off and/or supplying a fluid, for use in microfluidic analytical equipment, includes an elongated first tube having a first channel that is open to the outside in the area of a free end of the conduit and a second tube having a second channel arranged along the first channel that is also open to the outside in the area of the free end of the conduit, where the second channel is spiral-wound.

The invention relates to a conduit, in particular, a conduit for drawing off and/or supplying a fluid, in particular, for use in the field of microfluidics, preferably on microfluidic analytical equipment, having an elongated first tube comprising a first channel for drawing off and/or supplying fluid that is open to the outside in the area of a free end of the conduit and a second tube comprising a second channel for drawing off and/or supplying fluid that is arranged along the first channel and is also open to the outside in the area of the free end of the conduit.

In the case of applications in the field of microfluidic analytical equipment, small to extremely small quantities of samples and/or reagents must supplied to, or drawn off from, the desired application points, for example, miniature vessels, such as so-called “microwells” on microtitration plates and/or microfluid chips. The fluids involved are thus usually supplied and/or drawn off by pumps, where application conduits or suction conduits that may be manipulated using suitable handling devices provide for a transport of the fluids to be applied or drawn off from larger containers, to the miniature containers, or vice versa. Such conduits are usually in the form of needles having relatively large internal cross-sections that must be inserted into the miniature vessels from above.

Two needles or tubes may be provided in order to prevent contamination and admixing of the fluids to be drawn off and the fluids to be supplied, in which case, one of the needles may be used to supply a first fluid and the other needle may be used to draw off a second fluid.

In the course of an automation procedure, supplying and/or drawing off fluids must take place at relatively large volume flow rates and pressure drops that are maintained as low as possible, which is why the known needles have relatively large internal cross-sections. However, in that case, fluid that can drip out of the conduit no later than when the vacuum pump is shut off may remain in the suction needle when drawing off fluid from the miniature vessels, a phenomenon that may also be caused by air that is simultaneously inducted. Since that may occur spontaneously, i.e., at an unpredictable point in time, one or more fluid droplets may drop off in an uncontrolled manner, which is unacceptable.

A task addressed by the invention is thus, in particular, avoiding the aforementioned disadvantages.

According to the invention, that task is accomplished by those features stated under claim 1, in particular, by providing that the second channel is spiral-wound.

The invention thus involves increasing the flow rate in that channel in order that there will be a serial transport of fluid and air in that channel, under which inducted air effectively “entrains” the fluid, by creating a spiral-wound, or helical, second channel, preferably a channel for drawing off fluids. In addition, those parts of the spiral-wound second channel arranged at a certain pitch angle with respect to the vertical, longitudinal, axis of the conduit, or the first tube, prevent fluid from dripping out and falling downward.

Thanks to the measures according to the invention, less, or no, fluid will remain in the suction conduit, in this case, the second channel, and any residual fluid that may remain therein will be distributed over a relatively large surface area, to which the fluid will adhere to some extent. The problem of droplet formation and uncontrolled dropping off of fluid droplets may be avoided in this manner.

According to a beneficial embodiment of the invention, it may be provided that the second channel is spiral-wound around the first channel.

According to a particularly beneficial embodiment of the invention, it may also be provided that the first tube is arranged within the second tube, while forming an elongated annular gap extending along the length of the first tube, by configuring a spiral enclosing the first tube that extends along the lengths of both the first tube and the second tube. Such a conduit may be simply and inexpensively manufactured, and will further reduce drippage. The fluid is preferably supplied through the first tube and drawn off, or inducted, through the second tube. It will be particularly beneficial if the spiral is configured in the form of a, preferably resilient, compressible and/or extensible, helical spring, which, in addition to the aforementioned benefits, will allow simple, rapid, and reliable cleaning of the fluid-carrying portions of the conduit. The helical spring involved is thus preferably a component that may be handled separately prior to assembly of the conduit.

It will also be favorable if the helical spring has an outer diameter that is slightly less than the inner diameter of the second tube and if the helical spring has an inner diameter that is slightly greater than the outer diameter of the first tube, i.e., if the thickness of the helical spring preferably essentially equals the width of the annular gap or essentially fills the annular gap.

When a helical spring is employed, the tendency toward uncontrolled dripping will be further reduced if it is arranged with a pretensioning acting along the length of the first tube, in particular, if, in the vicinities of both of its ends, the helical spring abuts against ferrules rigidly attached to the first tube and/or the second tube, while exerting compressive forces thereon, where the ferrule in the area of the free end of the conduit is preferably rigidly attached to the second tube.

In the case of applications involving filling or emptying so-called “wells,” it will be particularly beneficial if the first tube may be translated along the second tube such that the first tube may be displaced from a first position, in which it protrudes from that end of the second tube that is open to the outside, to a second position, in which the free end of the first tube is arranged roughly at the location of the free end of the second tube, and back again, in particular, if the first tube is fabricated from a flexible material, for example, from Teflon, and the second tube is fabricated from a, comparatively, stiffer material, for example, stainless steel, in order that an elastic, longitudinal displacement of the free end of the first tube toward the free end of the second tube will be effected when compressive forces are exerted on the free end of the first tube. Fluid may then be totally drawn off from the relatively flat “wells” using the second tube, whose channel port will then be arranged near the bottoms of the respective “wells” when the first tube is driven inward. Moreover, the “spring loaded,” protruding first tube may be employed for either supplying fluid or drawing off fluid, for example, in the case of applications involving drawing off fluid through an aperture or a hole in a “well.” However, in such cases, subsequent cleaning of the conduit will be necessary.

According to a preferred application of the conduit according to the invention in the field of microfluidics and/or in order to guarantee the desired proper operation, it will also be beneficial if the width of the annular gap is less than 2 mm and/or the inner diameter of the first tube is less than 8 mm.

Other benefits, features, and aspects of the invention will be evident from the following description section, in which a preferred embodiment thereof will be described.

The figures depict:

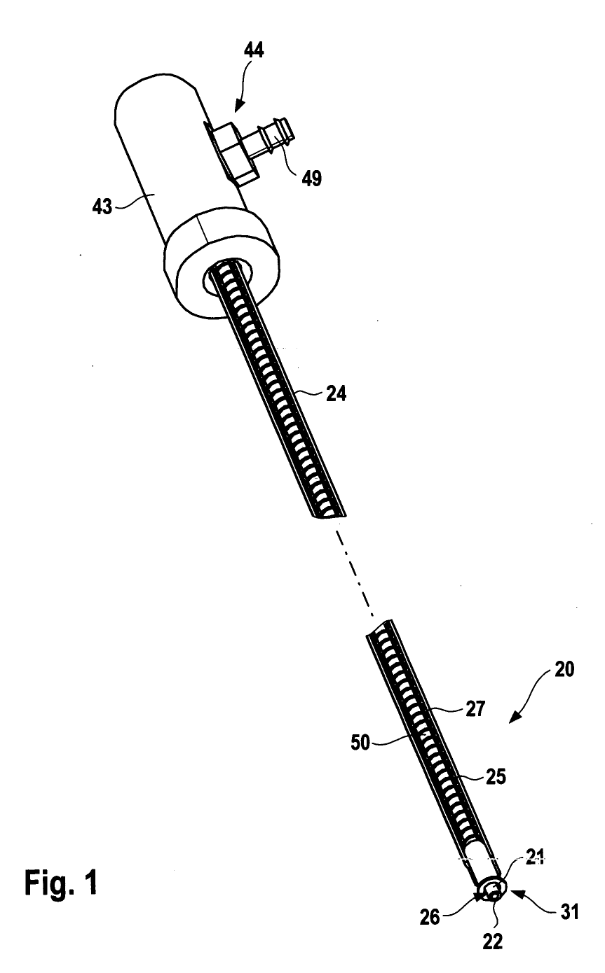

FIG. 1 a three-dimensional drawing of a conduit according to the invention having a fitting body for connecting interconnecting lines attached to the conduit, the midsection of which has been deleted;

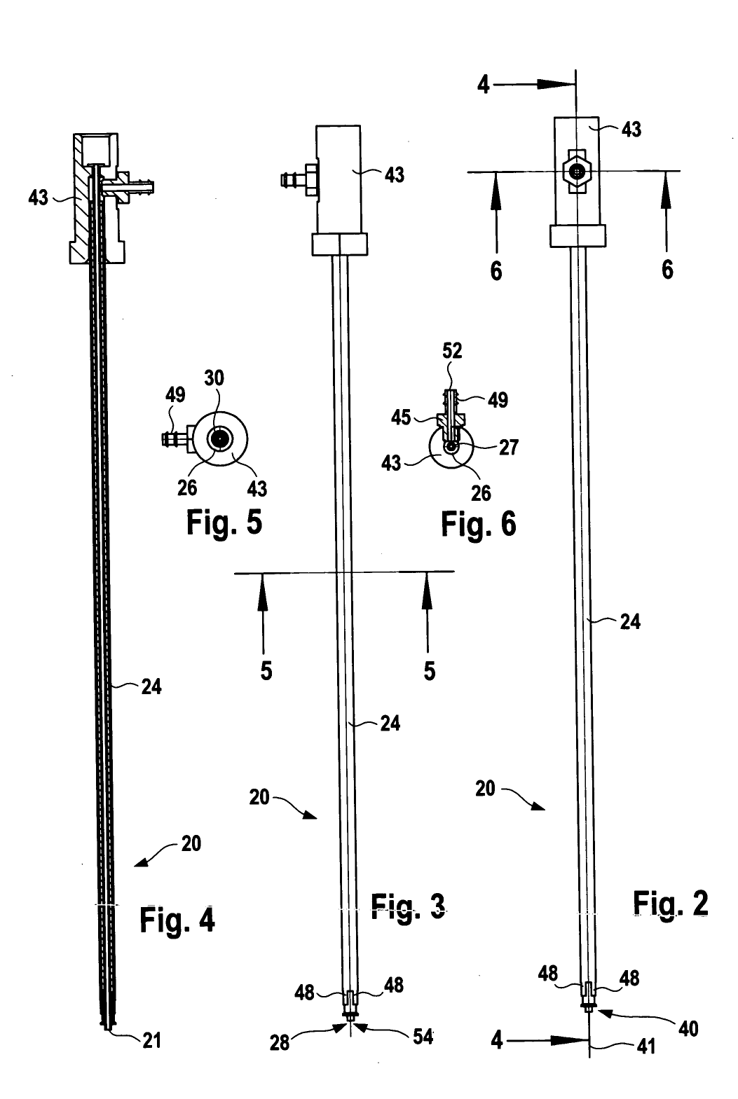

FIG. 2 a first plan view of the conduit shown in FIG. 1;

FIG. 3 a plan view of the conduit shown in FIG. 2, in which the conduit has been rotated clockwise through 90°, as viewed from above;

FIG. 4 a view of the conduit, longitudinally sectioned along the line 4-4 appearing in FIG. 2;

FIG. 5 a view of the conduit, transversely sectioned along the line 5-5 appearing in FIG. 3;

FIG. 6 a view of the conduit, transversely sectioned along the line 6-6 appearing in FIG. 2;

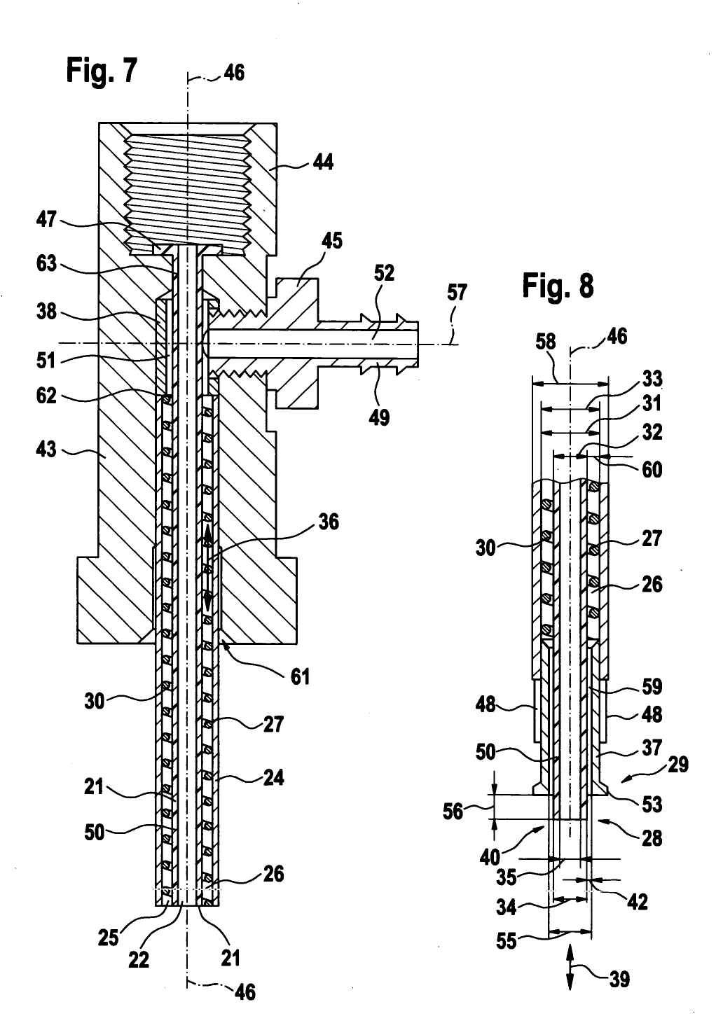

FIG. 7 a greatly enlarged, longitudinally sectioned view of the upper portion of the conduit, in the area of the fitting body;

FIG. 8 a greatly enlarged, longitudinally sectioned view of the lower section of the conduit, in the area of its free end.

The conduit 20 comprises, as its essential components, a first tube 21, a second tube 24, a ferrule 37 arranged on the free end 23 of the conduit 20, and a fitting body 43 attached to the opposite end of the conduit 20.

The first, elongated tube 21 is here configured in the form of a hose 50, preferably fabricated from Teflon. The first tube 21 comprises an elongated first channel 22 for drawing off and/or supplying a fluid that is open to the outside in the area of the free end 23 of the conduit 20, i.e., at the free end 28 of the first tube 21. An annular flange 47 (cf. FIG. 7) that extends radially outward from the longitudinal axis 46 and is roughly orthogonal thereto, and is used for fastening and sealing the first tube 21 to a screw fitting, which that has not been shown in detail, having in exterior thread that may be screwed into an internal thread of the central fitting 44 is arranged on the end of the first tube 21 opposite its free end 28. The first tube 21 has an inner diameter 35 of, for example, 0.7 mm, and an outer diameter of, for example, 1.2 mm.

The first tube 21 is arranged within a second tube 24, while forming an annular gap 26. The outer, elongated tube 24 preferably consists of stainless steel, and has an outer diameter of 58 of, for example, 2.8 mm and an inner diameter of, for example, 2.15 mm. The first tube 21 is arranged roughly coaxially with respect to the second tube 24, and has a low radial clearance with respect to the latter. The annular gap 26 formed between the first tube 21 and the second tube 24 has a width 42 that equals about half the difference between the inner diameter 33 of the of the second tube 24 and the outer diameter 34 of the first tube 21.

A helical spring 30 that is also referred to as a “spiral” 27 having a certain pitch angle in order that the respective portions of the spiral will make an angle corresponding to the pitch of the spiral with respect to the longitudinal axis 46 is arranged in the annular gap 26. The outer diameter 31 of the helical spring 30 is slightly less than the inner diameter 33 of the second tube, and the inner diameter 32 of the helical spring 30 is slightly greater than the outer diameter 34 of the first tube 21 in order that the helical spring 30 will be retained on the first tube 21 and the second tube 24 with a slight amount of play, which will allow simply inserting the helical spring 30 onto the first tube 21 and into the second tube 24 from the free end 23 of the conduit 20, and installed in this manner. Furthermore, the helical spring 30 may, in this manner, be pretensioned, as described below, in order that the compressive forces (indicated by the double-headed arrow 36 in FIG. 7) may act.

The arrangement and configuration of the helical spring 30 yields a spiral-wound, or helical, second channel 25 in the chamber between the first tube 21 and the second tube 24 that is preferably used for drawing off, or inducting, fluid in the area of the free end 23 of the conduit, which, however, may also be used for supplying fluid.

A cylindrical ferrule 37 that is inserted part way into the annular gap 26 and held in place therein, for example, is bonded to the second tube 24, is arranged on the forward, free end 29 of the second tube 24. The second tube 24 has, here, four tongues 48 whose inner diameter equals the inner diameter 33 of the second tube 24 and whose outer diameter is, here, slightly less than the outer diameter of the 58 of the second tube 54, extending longitudinally along the conduit 20 on its free end 29. These tongues 48 allow an elastic buffering of lateral forces in order that the first tube 21, which is preferably configured in the form of a Teflon hose 50, will not become damaged in their area.

The free end 28 of the ferrule 37 is broadened, forming an annular flange 53 extending radially outward that serves as an abutment and support for the free end 28 of the first tube 21 at its application point, preferably at a location where fluid is to be inducted. The other end of the ferrule 37 has an annular abutment for that end of the helical spring 30 that abuts against it. The cylindrical ferrule 37 has an inner diameter 55 that exceeds the outer diameter 34 of the first tube 21 in order that an annular gap 59 having a radial width 42 will be formed in the area of the ferrule 37. The radial width 42 of the annular gap 59 is thus less than the width 60 of the annular gap 26, where the annual gap 59 runs out into the annular gap 26 and thus also into the helical second channel 25.

The conduit 20 has a fitting body 43 that is rigidly attached to, preferably bonded to, the second tube 24 is located in the area of that end opposite the free end 23 of the conduit 20. The fitting body 43 has a cylindrical bore 61, into which the second tube 24 may be inserted for that purpose. A cylindrical ferrule 38, one end of which abuts against a shoulder 63 that extends radially inward from the inner wall of the bore 61 and is terminated at its inner edge by a through hole, through which the first tube 21 is inserted, is inserted into the bore 61. The attachment end 62 of the second tube 24 abuts against that end of the ferrule 38 opposite its end that abuts against the shoulder 63. The cylindrical ferrule 38 has an inner diameter that is slightly greater than the inner diameter 33 of the second tube 24 in order that an abutment shoulder for the compression spring 30 will be formed. An annular chamber 51 whose radial width is less than the width 60 of the annular gap 26 is formed between the ferrule 38 and the first tube 21 passing longitudinally through it.

A channel 52 of a lateral fitting 45 that runs out into the annular chamber 51, which, in turn, runs out into the annular gap 26, and thus into the helical second channel 25, is arranged roughly orthogonal to the longitudinal axis 46 of the conduit 20. The fitting 45 has an exterior thread that may be screwed into a mating internal thread on the its tip 44. The fitting 45 has a hose fitting 49 for attaching a hose, which has not been shown, that may be inserted onto the hose fitting 49, on its free end.

In the relaxed position shown in FIGS. 1-4 and FIG. 8 (the first position thereof (40)), in which the free end 28 of the first tube 21 protrudes from the forward ferrule 37, and from the free end of the second tube 24, by a distance 56 of, for example, 1 mm. Due to the flexibility and elasticity of the material chosen for fabricating the first tube 21, along with the slight amounts of play between the first tube 21 and the forward ferrule 37 and between the first tube 21, the helical spring 30, and the second tube 24, the free end 28 of the first tube 21 may be forced back when a compressive force 41 (cf. FIG. 2) is exerted on it in the direction 41 indicated, which will be accompanied by a simultaneous increase in the elastic restoring forces acting on the first tube 21, to at least one second position, in which the free end 28 of the first tube is approximately flush with the free end 29 of the second tube and the forward ferrule 37, which will allow extending the outer face of the annular flange 53 on the forward ferrule 37 out to the immediate area of a desired level within a fluid to be inducted in order to allow drawing off all of the fluid, or totally emptying the vessel containing the fluid down to that level, when the fluid is inducted through the second channel 25.

In the relaxed position of the first tube 21, in which it extends beyond free end 29 of the second tube 24, the first tube 21 may also be used for drawing off a fluid, for example, drawing off a fluid through an aperture or a hole whose inner dimensions only slightly exceed the outer diameter of the first tube 21, but are less than the outer diameter of the annular flange 53 on the second tube 24, which will thus also allow efficiently drawing off fluids through even very tiny apertures or holes using the conduit 20.

It should be obvious that the invention is not confined to the case of a conduit having just a single first tube and a single second tube 24, combined with a single helical channel 25 situated between them, and that several nested tubes arranged either one within the another or parallel to one another and/or several helical channels or helical springs will also be feasible.

1. A conduit for drawing off and/or supplying a fluid, comprising
an elongated first tube having a first channel for drawing off and/or supplying fluid, the first channel being open to the outside in an area of a free end of the conduit and
a second tube having a second channel for drawing off and/or supplying fluid, the second channel being arranged along the first channel and is also open to the outside in the area of the free end of the conduit, wherein the second channel is spiral-wound.

2. A conduit according to claim 1, wherein the second channel is spiral-wound around the first channel.

3. A conduit according to claim 1, wherein the first tube is arranged within the second tube while forming an elongated annular gap extending along the first tube due to the fact that it is configured in the form of a spiral wound around the first tube extending along both the first tube and the second tube.

4. A conduit according to claim 3, wherein the spiral is configured in the form of a helical spring.

5. A conduit according to claim 4, wherein the helical spring has an outer diameter that is slightly less than the inner diameter of the second tube, and wherein the helical spring has an inner diameter that is slightly greater than the outer diameter of the first tube.

6. A conduit according to claim 4, wherein the helical spring is arranged with a pretensioning acting along the length of the first tube.

7. A conduit according to claim 6, wherein, in the vicinities of its ends, the helical spring abuts against ferrules rigidly attached to the first tube and/or the second tube, while exerting compressive forces thereon.

8. A conduit according to claim 1, wherein the first tube may be translated along the second tube such that it may be displaced from a first position, in which it protrudes from that end of the second tube that is open to the outside, to a second position, in which the free end of the first tube is arranged roughly at the location of the free end of the second tube, and back again.

9. A conduit according to claim 8, wherein the first tube is fabricated from a flexible material, and wherein the second tube is fabricated from a, comparatively, stiffer material in order that an elastic, longitudinal displacement of the free end of the first tube toward the free end of the second tube will be effected when compressive forces are exerted on the free end of the first tube.

10. A conduit according to claim 3, wherein the width of the annular gap is less than 2 mm.

11. A conduit according to claims 1, wherein the inner diameter of the first tube is less than 8 mm.
